(19) United States
(12) Patent Application Publication
(10) Pub. No.: US 2025/0236250 A1
(43) Pub. Date: Jul. 24, 2025

(54) VEHICLE BUMPER BEAM

(71) Applicant: SUBARU CORPORATION, Tokyo (JP)

(72) Inventor: Naoki NISHIMURA, Tokyo (JP)

(21) Appl. No.: 18/974,107

(22) Filed: Dec. 9, 2024

(30) Foreign Application Priority Data
Jan. 24, 2024 (JP) 2024-008969

(51) Int. Cl. B60R 19/18; B60R 19/02

(52) U.S. Cl. CPC B60R 19/18; B60R 19/023; B60R 2019/1813

(57) ABSTRACT

A vehicle bumper beam includes: a first panel extending in a vehicle width direction and defining a receiving surface of a collision load of the vehicle; a second panel extending in the vehicle width direction and facing the first panel in a front-rear direction of a vehicle body; third panels in a pair extending from an upper edge and a lower edge of the second panel in the front-rear direction of the vehicle body and coupled respectively to an upper edge and a lower edge of the first panel; and beads provided in the middle of one or more of the third panels in the vehicle width direction and extending from the first panel to the second panel. Extending ends of the beads are set at positions apart from a ridge line between the second panel and a corresponding one of the third panels on which the beads are provided.

### CROSS-REFERENCE TO RELATED APPLICATIONS

The present application claims priority from Japanese Patent Application No. 2024-008969 filed on Jan. 24, 2024, the entire contents of which are hereby incorporated by reference.

### BACKGROUND

The disclosure relates to a vehicle bumper beam extending in a vehicle width direction.

In the related art, a vehicle such as an automobile includes a bumper at a front part of a vehicle body to absorb a collision load from the front. Such a bumper includes a bumper beam extending in a vehicle width direction and a pair of left and right crash boxes.

### SUMMARY

An aspect of the disclosure provides a vehicle bumper beam for a vehicle. The vehicle bumper beam includes a first panel, a second panel, and third panels a pair. The first panel extends in a vehicle width direction of the vehicle and defines a receiving surface of a collision load of the vehicle. The second panel extends in the vehicle width direction and faces the first panel in a front-rear direction of a vehicle body of the vehicle. The third panels extend from an upper edge and a lower edge of the second panel in the front-rear direction of the vehicle body and are coupled respectively to an upper edge and a lower edge of the first panel. The beads are provided in a middle of one or more of third panels in the vehicle width direction and extending from the first panel to the second panel. Extending ends of the beads are set at positions apart from a ridge line between the second panel and a corresponding one of the third panels on which the beads are provided.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a perspective view illustrating a vehicle body frame of a front part of a vehicle.

FIG. 2 is a plan view illustrating the vehicle body frame of the front part of the vehicle.

FIG. 3 is a perspective view illustrating a bumper beam.

FIG. 4 is an exploded perspective view of the bumper beam.

FIG. 5 is a cross-sectional view taken along a line V-V in FIG. 2.

FIG. 6 is a plan view illustrating the vehicle body frame of the front part of the vehicle at a time of a light collision.

FIG. 7 is a diagram illustrating stress distribution of the bumper beam at the time of the light collision.

FIG. 8 is a plan view illustrating a vehicle body frame of a front part of a vehicle at a time of a light collision according to a comparative example.

FIG. 9 is a diagram illustrating stress distribution of a bumper beam at the time of the light collision according to the comparative example.

FIG. 10 is a perspective view of a bumper beam according to a modified example.

FIG. 11 is a diagram illustrating stress distribution of the bumper beam at a time of a light collision according to the modified example.

FIG. 12 is a perspective view of a bumper beam according to a modified example.

### DETAILED DESCRIPTION

In general, a bumper beam is provided with beads capable of controlling buckling of the bumper beam. For example, Japanese Unexamined Patent Application Publication (JP-A) No. H7-205732 discloses a technique in which parallel beads extending from a front end to a rear end of a bumper beam (reinforcement main body) are formed on panels that constitute upper and lower surfaces of the bumper beam. For example, when the beads are provided at two positions on left and right sides of the bumper beam, the bumper beam buckles at the two left and right positions with the beads serving as starting points at a time of a vehicle collision. By setting such a buckling position at laterally symmetrical positions of the bumper beam, the bumper beam deforms rearward of a vehicle body while reducing the amount of rearward movement of a vehicle body at a time of a light collision, and efficiently absorbs a collision load.

However, when a collision load (stress) is unevenly transmitted to the vicinity of one bead at one position among the beads at positions on the bumper beam due to a pole collision or the like, the bumper beam may simply buckle greatly at the one position. In such a case, a buckling shape of the bumper beam greatly differs between the left and right sides, and it is difficult to reduce a displacement amount due to the buckling of the bumper beam. As a result, a part of the buckled bumper beam may be greatly displaced rearward of the vehicle body, and in-vehicle components may be damaged.

It is desirable to provide a vehicle bumper beam capable of reducing a displacement amount due to buckling even when a stress is unevenly transmitted at a time of a light collision.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

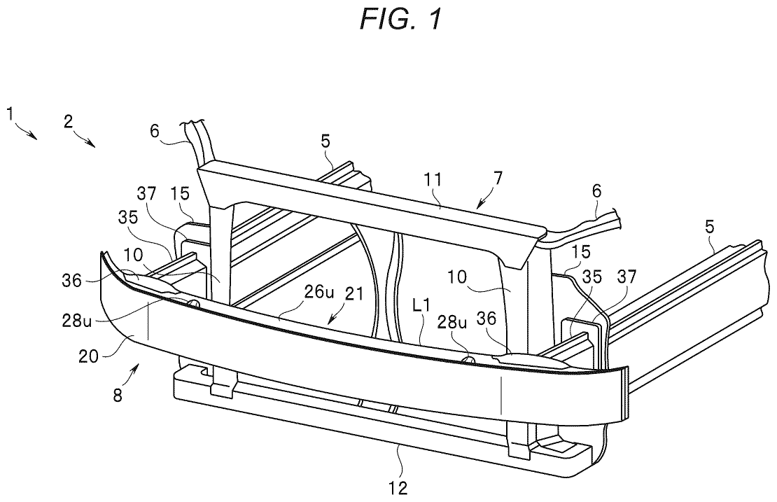

FIG. 1 is a perspective view illustrating a vehicle body frame of a front part of a vehicle according to an embodiment of the disclosure.

As illustrated in FIG. 1, a vehicle body 2 that constitutes a front part of a vehicle 1 is implemented by, for example, assembling panel-shaped members obtained by press-molding a steel plate and joining the panel-shaped members by spot welding or the like.

The vehicle body 2 includes a pair of left and right front side frames 5, a pair of left and right upper side frames 6, a radiator support 7, and a bumper beam 8.

Each of the front side frames 5 extends in a front-rear direction of the vehicle body 2. Further, base ends of the front side frames 5 are bent downward to be coupled to left and right side sills (not illustrated).

The upper side frames 6 extend in the front-rear direction of the vehicle body 2 above the front side frames 5, respectively. Further, base ends of the upper side frames 6 are coupled to a front edge of a front pillar (not illustrated).

The radiator support 7 includes a pair of left and right radiator support side parts 10, a radiator support upper part 11, and a radiator support lower part 12.

Upper ends of the radiator support side parts 10 are joined to left and right ends of the radiator support upper part 11, respectively. Lower ends of the radiator support side parts 10 are joined to left and right ends of the radiator support lower part 12, respectively.

Each of the radiator support side parts 10 is provided with a plate-shaped frame attachment part 15 protruding outward in a vehicle width direction. Rear surfaces of the frame attachment parts 15 are coupled to front ends of the front side frames 5 by welding or the like, respectively.

Further, the left and right ends of the radiator support upper part 11 are coupled to front ends of the upper side frames 6 by welding or the like, respectively.

Thus, the radiator support 7 is supported by the front side frames 5 and the upper side frames 6.

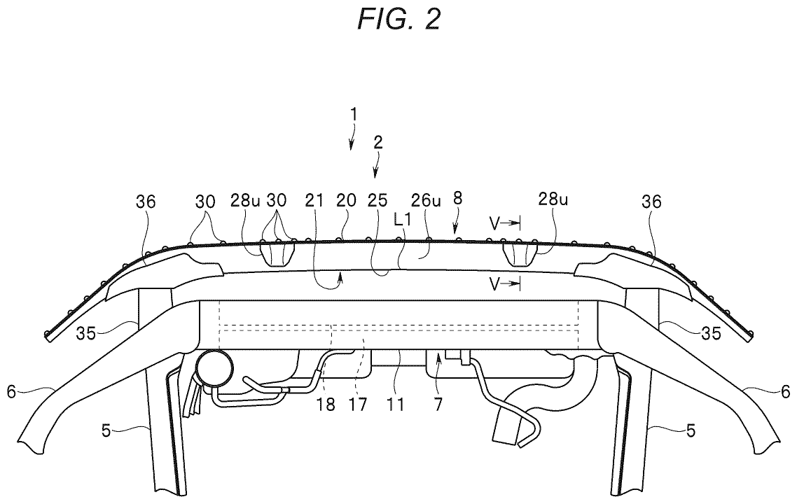

As illustrated in FIG. 2, a radiator 17 and an air conditioning condenser 18 are attached to an inside of the radiator support 7.

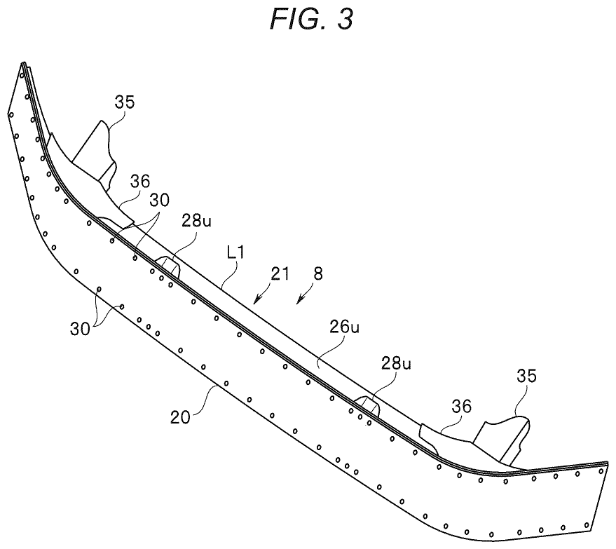

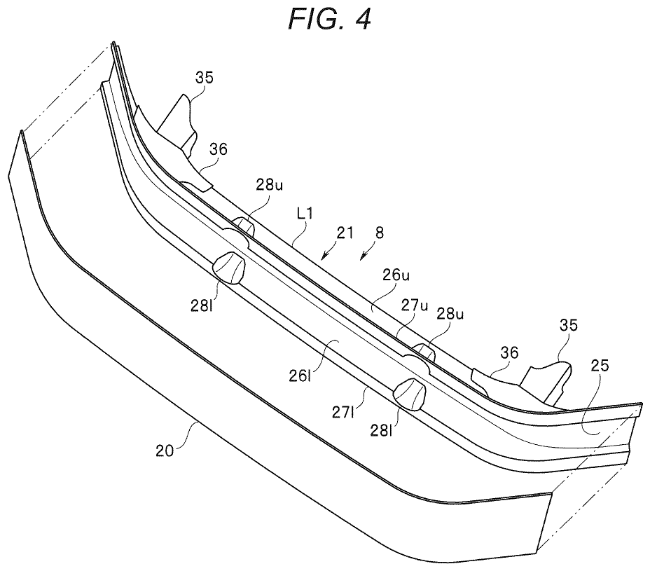

As illustrated in FIGS. 2 to 5, the bumper beam 8 includes a front panel 20 serving as a first panel and a beam main body 21.

The front panel 20 is made of an elongated sheet metal member having an approximately rectangular shape in a front view. The front panel 20 extends in the vehicle width direction (left-right direction) of the vehicle body 2. Accordingly, the front panel 20 constitutes a front wall of the bumper beam 8. A front wall surface of the front panel 20 defines a receiving surface for receiving a collision load by the bumper beam 8 at a time of a frontal collision of the vehicle 1.

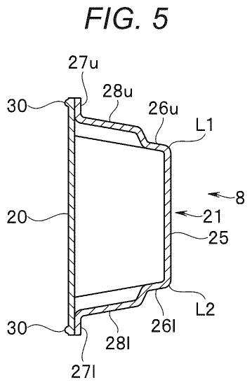

The beam main body 21 includes a rear panel 25 serving as a second panel, an upper panel 26u and a lower panel 26l serving as third panels, and a pair of flanges 27u and 27l. In the present embodiment, the rear panel 25, the upper panel 26u, the lower panel 26l, and the pair of flanges 27u and 27l are permanently affixed with each other by pressing a sheet metal member. Accordingly, the beam main body 21 has an approximate hat shape in cross section (see FIG. 5).

The rear panel 25 has an approximately rectangular shape in a front view. The rear panel 25 extends in the vehicle width direction in a state of facing the front panel 20 behind (in the front-rear direction of) the vehicle body 2.

The upper panel 26u and the lower panel 26l extend forward (in the front-rear direction) of the vehicle body 2 from an upper edge and a lower edge of the rear panel 25, respectively.

The flanges 27u and 27l extend upward and downward from front edges of the upper panel 26u and the lower panel 26l, respectively. The flanges 27u and 27l are shaped to be capable of abutting against an upper edge and a lower edge at a rear surface of the front panel 20. The flanges 27u and 27l are joined to the front panel 20 by spot welding or the like. Accordingly, the flanges 27u and 27l couple extending ends of the upper panel 26u and the lower panel 26l to the upper edge and the lower edge of the front panel 20, respectively.

In the bumper beam 8 having such a basic configuration, the upper panel 26u and the lower panel 26l have beads in the middle in the vehicle width direction. In the present embodiment, the upper panel 26u includes two first beads 28u serving as beads. The lower panel 26l includes two second beads 28l serving as beads. The first beads 28u and the second beads 28l form starting points for buckling the bumper beam 8 when a collision load is received by the bumper beam 8.

The two first beads 28u are provided, for example, at positions symmetrical in the vehicle width direction (laterally symmetrical positions) with reference to a center of the upper panel 26u in the vehicle width direction.

Each of the first beads 28u is implemented by a protruding bead protruding upward from an outer surface of the upper panel 26u. That is, each first bead 28u is implemented by a protruding bead protruding outward of the bumper beam 8. Each first bead 28u may also be implemented by a recessed bead recessed downward from the outer surface of the upper panel 26u.

Each first bead 28u extends from the front panel 20 to the rear panel 25. In this case, a position of an extending end of each first bead 28u is set at a position apart from a ridge line L1 between the upper panel 26u and the rear panel 25. That is, the extending end of each first bead 28u is spaced from the ridge line L1 by a predetermined interval.

The two second beads 28l are provided, for example, at positions symmetrical in the vehicle width direction with reference to a center of the lower panel 26l in the vehicle width direction. Further, the two second beads 28l are provided at positions facing the two first beads 28u respectively in the vehicle width direction.

Each of the second beads 28l is implemented by a protruding bead protruding downward from an outer surface of the lower panel 26l. That is, each second bead 28l is implemented by a protruding bead protruding outward of the bumper beam 8. Each of the second beads 28l may also be implemented by a recessed bead recessed upward from the outer surface of the lower panel 26l.

Each of the second beads 28l extends from the front panel 20 to the rear panel 25. In this case, a position of an extending end of each second bead 28l is set at a position apart from a ridge line L2 between the lower panel 26l and the rear panel 25. That is, the extending end of each second bead 28l is spaced from the ridge line L2 by a predetermined interval.

In some embodiments, herein, for example, as illustrated in FIG. 2, among pitches between welding points 30 for joining the front panel 20 to each of the flanges 27u and 27l, a pitch in regions where the first beads 28u and the second beads 28l are provided are different from a pitch in other regions. For example, in some embodiments, the pitch between the welding points 30 in the regions where the first beads 28u and the second beads 28l are provided is set to be shorter than the pitch between the welding points 30 in other regions.

The bumper beam 8 having such a configuration is attached to the vehicle body 2 via a pair of left and right crash boxes 35.

That is, a tip end of each crash box 35 is joined to the beam main body 21 via a bracket 36. In this case, a position where each crash box 35 is joined to the beam main body 21 is set on the outer side in the vehicle width direction in respect to the regions where the first beads 28u and the second beads 28l are provided.

A base end of each crash box 35 is joined to a front surface of each frame attachment part 15 via a flange 37.

Thus, the bumper beam 8 is attached to the vehicle body 2 with a predetermined interval between the bumper beam 8 and the condenser 18. The bumper beam 8 along with the crash boxes 35 constitute a frame of a front bumper.

The bumper beam 8 having such a configuration buckles while absorbing the collision load at the time of the frontal collision of the vehicle 1. The bumper beam 8 buckles in such a manner with the first beads 28u and the second beads 28l serving as the starting points.

Herein, the pitch between the welding points 30 in the regions where the first beads 28u and the second beads 28l are provided is set to be shorter than the pitch between the welding points 30 in other regions. Accordingly, the collision load received by the bumper beam 8 is efficiently transmitted to the first beads 28u and the second beads 28l.

Further, the extending end of each first bead 28u and the extending end (rear end) of each second bead 28l are set at positions apart from the ridge line L1 and the ridge line L2. Accordingly, even when the first beads 28u and the second beads 28l are respectively provided on the upper panel 26u and the lower panel 26l, rigidity at a rear part of the bumper beam 8 is secured to a predetermined extent by the ridge line L1 and the ridge line L2. Since the rigidity is secured in this manner, a stress received by each of the first beads 28u and each of the second beads 28l is dispersed at the rear part of the bumper beam 8.

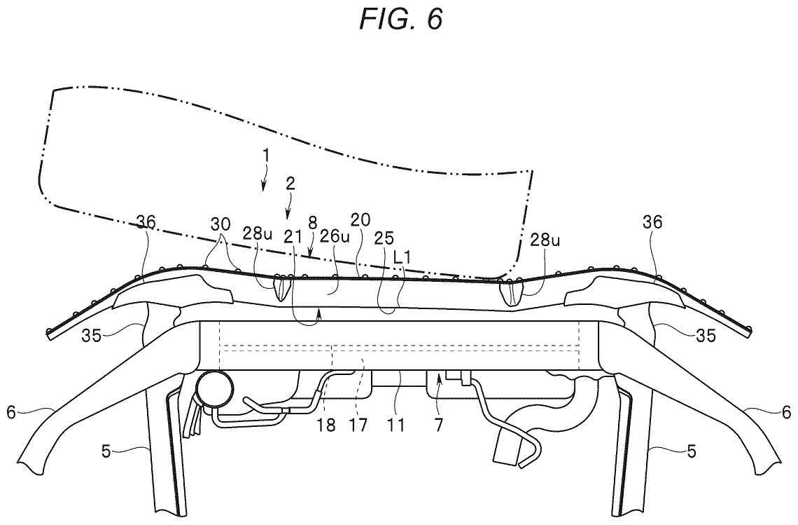

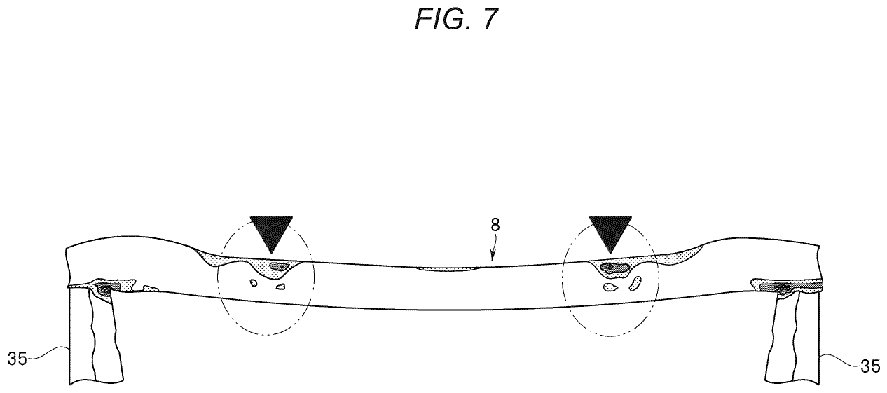

Therefore, for example, as illustrated in FIGS. 6 and 7, even when a collision load is unevenly applied to a position near one end of the bumper beam 8 in the vehicle width direction (for example, a position near a right side), the bumper beam 8 buckles approximately uniformly at two positions on left and right sides with the first beads 28u and the second beads 28l serving as the starting points. Accordingly, a displacement amount due to buckling of the bumper beam 8 can be reduced, and damage to the condenser 18, the radiator 17, and the like due to the buckled bumper beam 8 can be reduced.

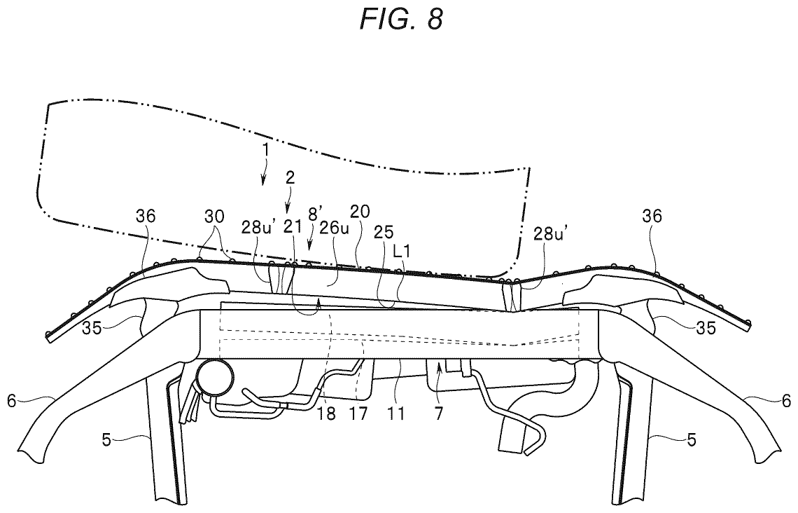

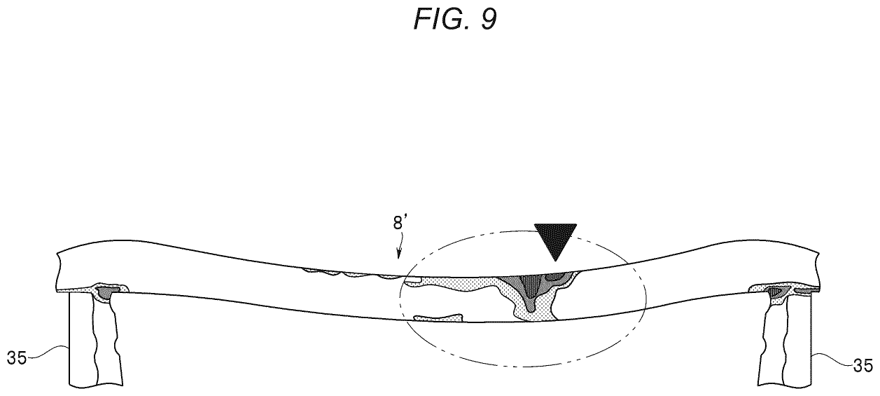

As a comparative example, FIGS. 8 and 9 illustrate a buckling behavior at a time of a frontal collision of a bumper beam 8′ in which each of first beads 28u′ and each of second beads 28l′ are extended to the ridge line L1 and the ridge line L2, respectively. In the bumper beam 8′ having such a configuration, a stress received by each first bead 28u′ and each second bead 28l′ is mostly transmitted to the ridge line L1 and the ridge line L2 without being dispersed. Therefore, when a collision load is unevenly applied to a position near one end of the bumper beam 8′ in the vehicle width direction, a buckling shape of the bumper beam 8′ greatly differs between left and right sides. As a result, even when a light collision of the vehicle occurs, a displacement amount due to buckling of the bumper beam 8′ is increased, and a possibility that the condenser 18, the radiator 17, and the like are damaged by the buckled bumper beam 8′ is increased.

According to such an embodiment, the bumper beam 8 includes the front panel 20 extending in the vehicle width direction, the rear panel 25 extending in the vehicle width direction and facing the front panel 20 in the front-rear direction of the vehicle body 2, the upper panel 26u and the lower panel 26l extending forward of the vehicle body 2 from the upper edge and the lower edge of the rear panel 25 and coupled to the upper edge and the lower edge of the front panel 20, respectively, and first beads 28u and second beads 28l provided in the middle of the upper panel 26u and the lower panel 26l in the vehicle width direction, respectively, and extending from the front panel 20 to the rear panel 25. The extending ends of first beads 28u are set at positions apart from the ridge line L1 between the upper panel 26u and the rear panel 25, and the extending ends of second beads 28l are set at positions apart from the ridge line L2 between the lower panel 26l and the rear panel 25. Thus, even when a stress is unevenly transmitted at the time of a light collision, the displacement amount due to the buckling of the bumper beam 8 can be reduced.

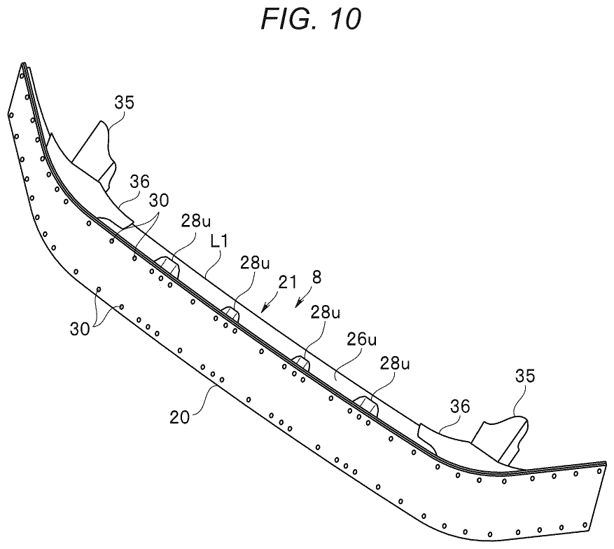

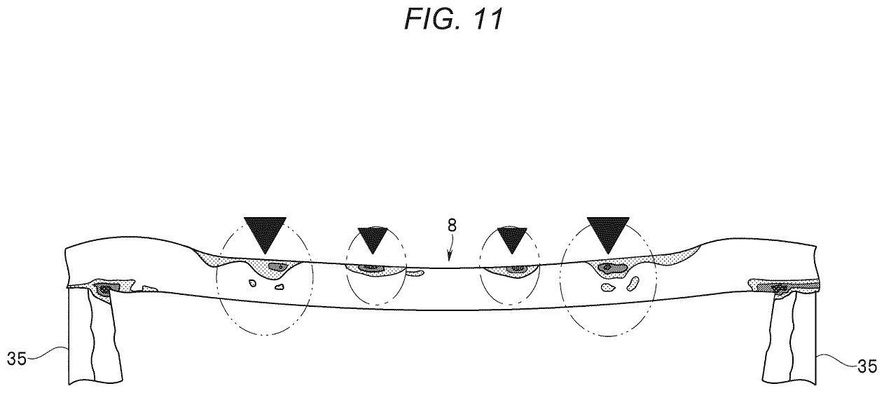

Herein, for example, as illustrated in FIG. 10, three or more (for example, four) first beads 28u (and second beads 28l) may also be provided at positions symmetrical with reference to a center of the bumper beam 8 in the vehicle width direction. With such a configuration, for example, as illustrated in FIG. 11, the bumper beam 8 can be buckled at a larger number of points, and the displacement amount due to the buckling of the bumper beam 8 can be reduced more effectively.

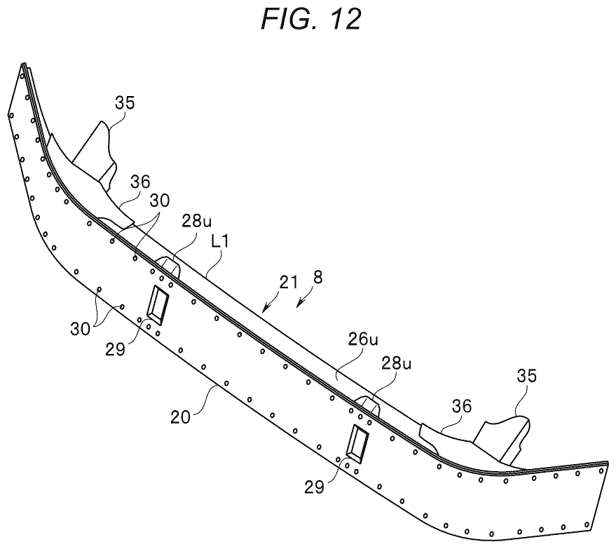

For example, as illustrated in FIG. 12, sub-beads 29 may also be provided on the front panel 20 at positions corresponding to the first beads 28u and the second beads 28l. With such a configuration, the buckling of the bumper beam 8 at a time of a collision can be properly implemented even when a rearward extension amount of each of the first beads 28u and each of the second beads 28l is reduced. By reducing the rearward extension amount of each of the first beads 28u and each of the second beads 28l, the extending end of each first bead 28u and the extending end of each second bead 28l can be sufficiently separated from the ridge line L1 and the ridge line L2, respectively. Therefore, the buckling of the bumper beam 8 due to the beads and stress dispersion can be implemented at a higher level.

The disclosure described in the above embodiments is not limited to these embodiments, and various modified examples may be made without departing from the gist of the disclosure at an implementation stage. For example, in the above embodiments, the configuration in which first beads 28u and second beads 28l are respectively provided on the upper panel 26u and the lower panel 26l is described. In contrast, beads may also be provided on at least one of the upper panel 26u and the lower panel 26l. In the above embodiments, an example in which the disclosure is applied to the bumper beam 8 of the front bumper is described. Alternatively, the disclosure may also be applied to a bumper beam of a rear bumper.

Further, the above embodiments include disclosures at various stages, and various disclosures can be extracted by appropriately combining disclosed elements. For example, even when some elements are removed from all the elements described in the above embodiments, a configuration from which these elements are removed can be extracted as a disclosure as long as the stated problem can be solved and the stated effects can be obtained.

According to the vehicle bumper beam of the disclosure, even when a stress is unevenly transmitted at a time of a light collision, a displacement amount due to buckling can be reduced.

1. A vehicle bumper beam for a vehicle, the vehicle bumper beam comprising:
a first panel extending in a vehicle width direction of the vehicle and defining a receiving surface of a collision load of the vehicle;
a second panel extending in the vehicle width direction and facing the first panel in a front-rear direction of a vehicle body of the vehicle;
third panels in a pair extending from an upper edge and a lower edge of the second panel in the front-rear direction of the vehicle body, the third panels being coupled respectively to an upper edge and a lower edge of the first panel; and
beads provided in a middle of one or more of third panels in the vehicle width direction and extending from the first panel to the second panel, wherein
extending ends of the beads are set at positions apart from a ridge line between the second panel and a corresponding one of the third panels on which the beads are provided.

2. The vehicle bumper beam according to claim 1, wherein
welding points are formed to join the first panel and the third panels by spot welding, and
a pitch between the welding points in regions where the beads are provided is set to be shorter than a pitch between the welding points in other regions.

3. The vehicle bumper beam according to claim 1, wherein
the first panel comprises sub-beads at positions corresponding to the beads.

4. The vehicle bumper beam according to claim 1, wherein
a joining position with a crash box of the vehicle is set on an outer side in the vehicle width direction in respect to the regions where the beads are provided.

5. The vehicle bumper beam according to claim 1, wherein
the second panel and the third panels are permanently affixed by pressing a sheet metal member.
